(19) United States
(12) Patent Application Publication
(10) Pub. No.: US 2014/0330766 A1
(43) Pub. Date: Nov. 6, 2014

(54) Positions and Interests Map

(71) Applicant: Mingji LOU, Corona, CA (US)

(72) Inventor: Mingji LOU, Corona, CA (US)

(21) Appl. No.: 13/875,187

(22) Filed: May 1, 2013

(51) Int. Cl. G06F 17/30

(52) U.S. Cl. CPC G06F 17/30241; G06F 17/30563
USPC 707/602

(57) ABSTRACT

A method to search concrete positions based on abstract interests or vice versa is disclosed. Based on user's initial inputs of interests to positions mapping (PI Map), this method extends the map further with other users' similar one. Weights are associated to each interest to position connection in the map to represent preferences. Multiple layers in the map are interconnected to have different level of abstraction. A personal PI Map database is established based on these initial inputs, extension, weights and multiple layers. When user inquires specific interests with constrain and execution order, the method use the PI Map to find the optimal route to concrete positions. Based on the users' usage and final choice, the PI Map is dynamically adjusted through connections and associated weight. Further data analytics is conducted based on the aggregated PI Map from a group of users.

### RELATIONSHIP TO OTHER FILING AND PRIORITY CLAIM

This application claims the priority filing date of May 1, 2012, of a provisional application by the same inventor, application Ser. No. 61/641,112.

### FIELD AND BACKGROUND OF THE INVENTION

Some current technologies on cell phone apps or other online/computer programs are designed to provide choices and guidance for users. But they are all based on objective information to create or collect other object information to indirectly meet users' interests. For example, GPS is to provide the route from user's current position to the target position; data-driven online advertising is based on user's browsing history to provide targeted advertise.

In other words, current searching systems are based on positions, such as the name of restaurant, specific model of products, etc. Some dynamic data collection methods are getting popular to explore the potential interests of people by using their browsing cache, online shopping history, etc.

There is still lack of understanding on users' subjective interests behind their choices; and users sometimes lose their original intention during online searching.

One barrier is those interests are subjective and most of time too fuzzy to be quantified; another barrier is search engines don't consider users multiple interests, positions, boundary conditions and preferences articulately, to conduct multiple layer interest to position or position to interest interpretation before generating solution. One series of classical algorithm to deal with PI Map with interests and positions is

Hidden Markov Models (HMMs). The three basic problems have been well studied in HMMs, which can be used in this invention:

Problem 1: Given the observation (e.g. positions in this invention) sequence and a model (e.g. PI Map), how to efficiently computer the probability of the observation sequence.

Problem 2: Given the observation sequence (e.g. positions) and the model (e.g. PI Map), how to choose a corresponding state sequence (e.g. interests), which is optimal in some meaningful sense (i.e., best “explains” the observations)?

Problem 3: How to adjust the model parameters (e.g. PI Map) to maximize the satisfaction of solutions from this method.

With this current level of interest/location modeling background, embodiments of the present application provide a method to map users' abstract interests into concrete positions, and navigate through multiple positions to meet compound interests with constrains such as location, time, money, etc.

### BRIEF DESCRIPTION OF THE DRAWINGS

FIG. 1 shows a typical flow chart of present invention;

FIG. 2 shows how to find hidden positions/interests based on user' inputs and inquiry history.

### DETAILED DESCRIPTION OF PREFERRED EMBODIMENT

A method to search concrete positions based on abstract interests or vice versa is disclosed. Based on user's initial inputs of interests to positions mapping (PI Map), this method extends the map further with other users' similar inputs. Weight is associated to each connection in the map to represent preferences. Multiple layers in the map are interconnected to represent different levels of abstraction. When users search for the positions to match multiple interests with constrain and execution order, the method uses the PI Map to find the optimal positions with shortest overall distance to those interests as solutions. Based on the users' usage and final choice, the PI Map is dynamically adjusted through connections and associated weight. Further data analytics is conducted based on the aggregated PI Map from a group of users.

The interest to position mapping will have three different types: one-to-one, one-to-many, or many-to-one, as explained more later.

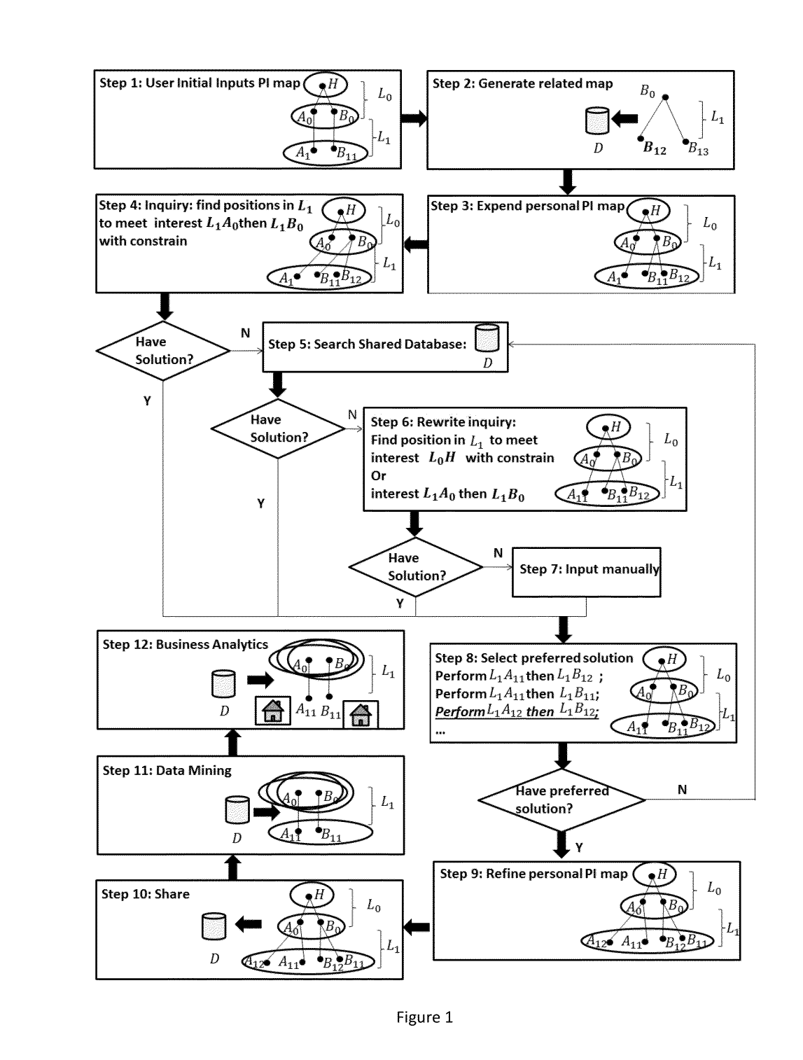

FIG. 1 is a flow chart of the present invention. In the block of step (1), user inputs its initial interests to position paring (PI Map). The aggregate “pairing” of interest to position form the map of interest to position map, PI Map. The interest is more abstract than the position. The map has at least one layer, and each layer has at least one group of positions and one group of interest; and they are connected with preferential weight matrix (π).

As shown in the step (1), in layer L₀, H is an abstract interest and it is connected with two concrete positions A₀ and B₀; in a more concrete layer L₁, A₀ and B₀ are interests related to more concrete positions A₁and B₁₁.

To clarify the notation convention in this application, use L₀A₀ and L₀B₀ to represent the A₀ and B₀ as position in layer L₀; use L₁A₀ and L₁B₀ represent the A₀ and B₀ as interest in layer L₁.

As shown in step (2), based on user's initial inputs, the method expends the PI Map from a database (D), which includes a group of users' shared PI Maps. For example, it suggests two alternative positions, L₁B₁₂ and L₁B₁₃, which connects with the interest L₁B₀. L₁B₁₂ is highlighted to user since most of other user places higher weight on L₁B₁₂ than L₁B₁₃. In step (2), the method may use different font or color for the display appearance of most related items with higher weight.

In the step (3), user accepts the expansion by including suggested L₁B₁₂ into its personal PI Map.

In the step (4), user inputs an inquiry with execution order: ‘Find position in L₁ to meet interest L₁A₀then L₁B₀, with constrain’. In this inquiry, L₁A₀ and L₁B₀ are the interests; and a user is looking for concrete positions to fulfill those interests within the boundary of constrain and following an execution order.

Alternatively, a user may input an inquiry with logic ‘and’: ‘Find position in L₁ to meet interest L₁A₀ and L₁B₀’; or with logic ‘or’: ‘Find position in L₁ to meet interest L₁A₀ or L₁B₀’.

Different optimization function for different type of inquiry will be applied as shown in Function (1)-(3). The cost is affiliated to each position to represent money or time consumptions. The constrain requires the summation of cost for all positions in one solution within a boundary, as shown in Function (1)-(3). If the method cannot find answers, it will search it in other users' shared IP map database D, in the step (5).

If it still cannot find the results, then in step (6), the method asks rewrite the inquiry. One way to rewrite the inquiry is to leverage interests to other in higher abstract layer and find alternative path to a position in the same abstract layer which inquiry asked for. For example, leverage L₁A₀ and L₁B₀ to L₀H , and still searching for positions in L₁, which have path to L₀H; the solution would be L₁B₁₁ only. Another option is to drop constrain.

If it still cannot find the results, in step (7), the method asks users to manually input all or partial of solutions.

In Step (8), multiple solutions created by the method are displayed with the order of their calculated distance between interests and positions. The distance is calculated by the summation of inverse of weight along the path of interests to positions, as shown in the Function(1)-(3), below.

A User selects the preferred solution in step (8). If there is no preferred solution from user's aspect, the user can ask to go through step 5 again.

As shown in the flow chart, the user selected preferred solution is highlighted: ‘Perform L₁A₁₂ then L₁B₁₂, for example. Note that in this example, the execution order is L₁A₁₂ firstly, then L₁B₁₂, which is following the order of interests in the inquiry; and L₁A₂ position didn't exist in the personal PI Map before. It is either coming from step 5 (shared PI Map database, D) or from step 7 (manual inputs). Those positions included in preferred solution will be propagated to personal PI Map by adding new position (L₁A₁₂ in this example) to connect with interest (L₁A₀) and increasing the weight for existing position L₁B₁₂, in the step (9).

This refined personal PI Map will be in further propagated to shared PI Map database (D) in the step (10).

In the step (11), a data mining process finds, for a group of users, most of users have common positions corresponding to interests L₁A₀and L₁B₀are postions L₁A₁₁ and

In the step (12), a business decision is to establish new products/service on L₁A₁₁ and L₁B₁₁ to best meet users' common interests L₁A₀ and L₁B₀. Another way to conduct data mining is to find the correlation among users' different interests. For example in the step (11), it finds most of users having interest L₁A₀, also having interest L₁B₀; in the step (12), a business decision is placing the position L₁B₁₁ next to L₁A₁₁.

Optimization function for the inquiry ‘Find positions in L₁ to meet interest L₁A₀ (first priority, a_{AU}) and L₁B₀ (second priority, a_{BO})’:

$${min}_{x , y} \{ {α}_{40} \times dist ( {A}_{0} {A}_{1 x} ) + {α}_{B 0} \times dist ( {B}_{0} {B}_{1 y} ) \vert cost ( {A}_{1 x} ) + cost ( {B}_{1 y} ) < constrain \} = {min}_{x , y} \{ \frac{{α}_{A 0}}{weight ( {A}_{0} {A}_{1 x} )} + \frac{{α}_{B 0}}{weight ( {B}_{0} {B}_{1 y} )} \vert cost ( {A}_{1 x} ) + cost ( {B}_{1 y} ) < Constrain \} \qquad Function ( 1 )$$

Optimization function for the inquiry ‘Find position in L₁ to meet interest L₁A₀ then L₁B₀’

$${min}_{x , y} \{ \frac{1}{weight ( {A}_{0} {A}_{1 x} )} + \frac{1}{weight ( {A}_{1 x} {B}_{1 y} ) + weight ( {B}_{0} {B}_{1 y} )} \vert cost ( {A}_{1 x} ) + cost ( {B}_{1 y} ) < Constrain \} \qquad Function ( 2 )$$

Optimization function for the inquiry ‘Find position in L₁ to meet interest L₁A₀ or L₁B₀’:

$${min}_{x , y} \{ \begin{matrix}\frac{1}{weight ( {A}_{0} {A}_{1 x} )} \vert cost ( {A}_{1 x} ) < Constrain \\ or , \\ \frac{1}{weight ( {B}_{0} {B}_{1 y} )} \vert cost ( {B}_{1 y} ) < Constrain\end{matrix} \} \qquad Function ( 3 )$$

One alternative usage of this method is to search for interests behind giving positions. In the step (4) of FIG. 1, the inquiry will be ‘Find interests in L₁ behind position L₁A₁ and L₁B₁₂’; and result will be L₁A₀ and L₁B₀.

If one position can meet multiple interests, the method finds the optimization solutions with minimum distance, as shown in Function (4).

Optimization function for the inquiry ‘Find interests in L₁ to meet position L₁A₁ (first priority, a_{A1}) and L₁B₁₂ (second priority, a_{B12})’:

$${min}_{x , y} \{ \frac{{α}_{A 1}}{weight ( {A}_{0 x} {A}_{1} )} + \frac{{α}_{B 12}}{weight ( {B}_{0 y} {B}_{12} )} \} \qquad Function ( 4 )$$

The second alternative usage of this method is to find the positions in other layers with different concrete level. In the step (4) of FIG. 1, the inquiry will be ‘Find position in L₁ to meet interest L₀H with constrain’. Notice that it looks for positions in L₁ layer, the different layer (layer L₀) of L₀H. The optimization function for this inquiry is following:

$${min}_{x , y} \{ \begin{matrix}\begin{matrix}\frac{1}{weight ( {H}_{0} {A}_{0} )} + \\ \frac{1}{weight ( {A}_{0} {A}_{1 x} )}\end{matrix} \vert cost ( {A}_{0} {A}_{1 x} ) < Constrain \\ \begin{matrix}\frac{1}{weight ( {H}_{0} {B}_{0} )} + \\ \frac{1}{weight ( {B}_{0} {B}_{1 y} )}\end{matrix} \vert cost ( {B}_{0} {B}_{1 y} ) < Constrain\end{matrix} \} \qquad Function ( 5 )$$

The third alternative usage of this method is to find hidden positions/interests based on user' inputs and inquiry history.

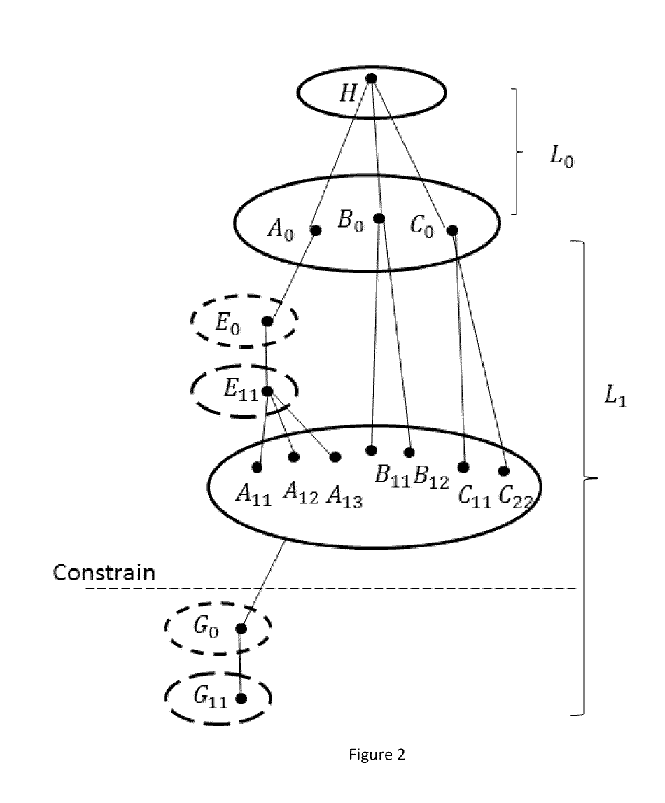

As shown in FIG. 2, user's original inquiry is to find positions in L₁ by giving interests L₁A₀, L₁B₀ and L₁C₀.

In scenario 1, the method detects the hidden interest L₁E₀ in the path from L₁A₀ to L₁A_{11/12/13}. The method will suggest to execute L₁E₁₁ to fulfill a hidden interest L₁E₀, which appeared in user's historical inquiry before.

In scenario 2, the method finds a more abstract layer L₀, which has a high weighted connection from L₀H to L₀B₀ in the personal PI Map. The method will modify the weight, a_{B0} in the Function (1) and (4), to let results have shortest distance to B₀.

In scenario 3, the method also breaks down a constrain to interest L₁G₀ and position L₁G₁₁. Consequently, constrain will be treated as an interest to create optimal solutions by calculating with other inquired interests.

What is claimed is:

1. A method to search concrete position based on abstract interest or vice versa comprises the steps of:
(1) Collect user initial inputs, personal interests and its corresponding positions in mind, to create an initial interest to position pairing, so as to have the aggregated parings form a map of interest to position map (PI Map);
(2) Based on user's initial inputs, suggests other alternative connections to user's initial inputs, based on a group of users' shared PI Map database, which includes other users' personal PI Map;
(3) User expends initial personal PI Map based on those suggestions by saving all or part of those suggestions into personal PI Map database;
(4) User inputs an inquiry including multiple interests, constrains, priorities, execution order, logic relationship and other information from other devices such as GPS, the method suggests multiple solutions including corresponding positions with specific priority, and execution order to meet the compounded interests with constrains, based on personal PI Map database and minimum distance principle;
(5) If the step (4) doesn't find the solutions which matches user's personal database, it searches a group of users' shared database to find the answer.
(6) If the step (5) doesn't find the solutions, the method interacts with user to rewrite inquiry including dropping constrains, or to route user's interests to more abstract layer and finding alternative path to position from there;
(7) If the step (6) doesn't find the solution, the method asks user manually inputs the positions as answer;
(8) User selects his/her preferred solution from multiple solutions suggested by the method;
(9) The method refines personal PI Map based upon user's selection and manual inputs in the step (8) by adding new positions corresponding to manual inputs and placing higher weight on the selected positions.
(10) Share user's personal PI Map in a group of users' shared PI Maps database;
(11) Data mining is conducted to find the commonality and correlation from statistics aspect, among a group of users' shared PI Maps database, its result is used to expend personal PI Map used in step (2) and (5); and,
(12) Data mining result is used for business analytics to create other desirable positions to meet users' common interests found in step (11).

2. In the claim 1, the PI Map has at least one layer, each layer has one group of interest and one group of positions, the interest is more abstract than the position in the same layer wherein the interest in one layer is a position for another more abstract layer, and the position in one layer is an interest for another more concrete layer.

3. In the claim 1, the interest to position mapping has three different types: one-to-one or one-to-many, or many-to-one mapping.

4. In the claim3, for those many-to-one and one-to-many mappings, weights (less than one) are assigned to represent different level of preference, for the one-to-one mapping, normalized weight one is assigned, wherein the weights are initialized at the beginning by the user in step (1) of claim 1, then refined in step (9) of claim 1.

5. In step (2) of claim 1, the method puts most related items with higher weight to be most appearing by using different font or color.

6. In step (2) and (10) of claim 1, user selects a group of users' shared database for data mining, such as friends and family's, or those people with higher similarity with user's existing personal PI Map.

7. In step 4 of claim 1, user decides how concrete the position results should be by routing the inquired interests to the positions in different layers with desired concrete level.

8. In the step 4 of claim 1, during the inquiry the cost of each position is searched online, this method will ensure the summarized cost of positions in every suggested solution is within the boundary of constrain.

9. In claim 1, step (4), execution order can be described by a sequence of interests which need to be fulfilled by a sequence of positions; logic relationship can be described by multiple interests connected with ‘and’, ‘or’ logic.

10. In the previous claims, the inquiry is to find positions by giving interests, and alternatively, the inquiry to find interests by giving positions is handled by replacing interest with position and by replacing position with interest in claim (1) to (9).

11. The method of claim 1, wherein the shared PI Map database includes aggregated users' individual PI Map, history of inquiry, and users' selection from solutions.
